(19) United States
(12) Patent Application Publication
(10) Pub. No.: US 2025/0382219 A1
(43) Pub. Date: Dec. 18, 2025

(54) GLASS COMPOSITION, GLASS OR GLASS FIBER INCLUDING THE SAME, AND PRODUCT INCLUDING THE GLASS FIBER

(71) Applicant: FULLTECH FIBER GLASS CORP., Douliu City (TW)

(72) Inventors: Wen-Ho HSU, Douliu City (TW); Bih-Cherng CHERN, Douliu City (TW); Ching-Shuo CHANG, Douliu City (TW); Chih-Yuan CHANG, Douliu City (TW); Wei-Chih LO, Douliu City (TW)

(21) Appl. No.: 19/219,345

(22) Filed: May 27, 2025

(30) Foreign Application Priority Data
Jun. 14, 2024 (TW) 113122178

(51) Int. Cl. C03C 13/00; C03C 3/118

(52) U.S. Cl. CPC C03C 13/00; C03C 3/118

(57) ABSTRACT

A glass composition includes silicon dioxide, aluminum oxide, diboron trioxide, fluorine, zinc oxide, a first component including calcium oxide, and a second component including zirconium dioxide and manganese oxide. Based on 100 wt % of the glass composition, the silicon dioxide is present in an amount ranging from 52 wt % to 62 wt %, the aluminum oxide is present in an amount ranging from 8 wt % to 13 wt %, the diboron trioxide is present in an amount ranging from 19 wt % to 31 wt %, and the fluorine is present in an amount of greater than 0 wt % and not greater than 2 wt %. Based on 100 wt % of the glass composition, the zinc oxide is present in an amount of equal to or greater than 0 wt % and less than 0.25 wt %. A glass or a glass fiber including the glass composition, and a product including the glass fiber are also provided.

### CROSS-REFERENCE TO RELATED APPLICATION

This application claims priority to Taiwanese Invention patent application No. 113122178, filed on Jun. 14, 2024, the entire disclosure of which is incorporated by reference herein.

### FIELD

The disclosure relates to a glass composition, and a glass or a glass fiber including the same. The disclosure also relates to a product including the glass fiber.

### BACKGROUND

TW 1766809 B discloses a low dielectric glass composition, a low dielectric glass, and a low dielectric glass fiber. The low dielectric glass composition includes, based on 100 wt % thereof, silicon dioxide (SiO₂) present in an amount ranging from 49 wt % to 59 wt %, aluminum oxide (Al₂O₃) present in an amount ranging from 9.5 wt % to 14.5 wt %, diboron trioxide (B₂O₃) present in an amount ranging from 19 wt % to 35 wt %, calcium oxide (CaO) present in an amount ranging from 2 wt % to 5 wt %, zinc oxide (ZnO) present in an amount ranging from 0.25 wt % to 3 wt %, magnesium oxide (MgO) present in an amount ranging from 0 wt % to 1 wt %, titanium dioxide (TiO₂) present in an amount ranging from 0 wt % to 1 wt %, zirconium dioxide (ZrO₂) present in an amount ranging from 0 wt % to 3 wt %, and manganese oxide (MnO) present in an amount ranging from 0.1 wt % to 3.5 wt %. The low dielectric glass includes the aforesaid low dielectric glass composition, and the low dielectric glass fiber also includes the same.

By having the above-mentioned components and each of the components being present in a predetermined amount range as set forth above, the low dielectric glass composition not only has a good forming window without the occurrence of phase separation, but also has a low dielectric constant and a low dielectric loss tangent. In addition, each of the low dielectric glass including the low dielectric glass composition and the low dielectric glass fiber including the low dielectric glass composition also has a low dielectric constant and a low dielectric loss tangent. However, when the low dielectric glass composition, the low dielectric glass, or the low dielectric glass fiber is used in an environment having a frequency of 10 GHz, the problems of having an excessive dielectric constant and an excessive dielectric loss tangent still exist.

In addition, when the inventors tried to find a way to reduce the dielectric constant and dielectric loss tangent of a glass composition, they found that the structural stability of the glass composition also needs to be taken into consideration. If the dielectric constant and dielectric loss tangent of the glass composition meet requirements, but the structural stability thereof is poor, surfaces of a glass formed from such glass composition may crack, causing debris to fall off from the surfaces of the glass, resulting in the glass having problems such as poor quality and poor yield. Moreover, cracking may also occur in a glass fiber formed from such glass composition, causing the glass fiber to have poor strength, resulting in the glass fiber having problems such as poor quality and poor yield.

### SUMMARY

Accordingly, in a first aspect, the present disclosure provides a glass composition, which can alleviate at least one of the drawbacks of the prior art. The glass composition includes:
silicon dioxide (SiO₂);
aluminum oxide (Al₂O₃);
diboron trioxide (B₂O₃);
fluorine (F₂);
zinc oxide (ZnO);
a first component including calcium oxide (CaO); and
a second component including zirconium dioxide (ZrO₂) and manganese oxide (MnO);
wherein based on 100 wt % of the glass composition, the silicon dioxide is present in an amount(S) ranging from 52 wt % to 62 wt %, the aluminum oxide is present in an amount (A) ranging from 8 wt % to 13 wt %, the diboron trioxide is present in an amount (B) ranging from 19 wt % to 31 wt %, and the fluorine is present in an amount of greater than 0 wt % and not greater than 2 wt %,
wherein based on 100 wt % of the glass composition, the zinc oxide is present in an amount of equal to or greater than 0 wt % and less than 0.25 wt %, and
wherein an amount (M) of the manganese oxide, an amount (X) of the first component, the amount (A) of the aluminum oxide, the amount(S) of the silicon dioxide, the amount (B) of the diboron trioxide, and an amount (Y) of the second component satisfy the following Equations (I) to (III):

$$M + X \leq 4.5 , \qquad ( I )$$

$$( M + X ) \times \frac{1}{A} = 0.2 ∼ 0.45 , and \qquad ( II )$$

$${( \frac{S}{B} )}^{2} \times {X}^{3 / 2} + 2 \times Y \times {( \frac{15}{A} )}^{2} = 16 ∼ 38.5 . \qquad ( III )$$

In a second aspect, the present disclosure provides a glass, which can alleviate at least one of the drawbacks of the prior art. The glass includes the aforesaid glass composition.

In a third aspect, the present disclosure provides a glass fiber, which can alleviate at least one of the drawbacks of the prior art. The glass fiber includes the aforesaid glass composition.

In a fourth aspect, the present disclosure provides a product, which can alleviate at least one of the drawbacks of the prior art. The product includes the aforesaid glass fiber.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### [Glass Composition]

The present disclosure provides a glass composition. According to the present disclosure, the glass composition includes silicon dioxide (SiO₂), aluminum oxide (Al₂O₃), diboron trioxide (B₂O₃), fluorine (F₂), zinc oxide (ZnO), a first component, and a second component. The first component includes calcium oxide (CaO), and the second component includes zirconium dioxide (ZrO₂) and manganese oxide (MnO).

According to the present disclosure, based on 100 wt % of the glass composition, the silicon dioxide is present in an amount(S) ranging from 52 wt % to 62 wt %, the aluminum oxide is present in an amount (A) ranging from 8 wt % to 13 wt %, the diboron trioxide is present in an amount (B) ranging from 19 wt % to 31 wt %, and the fluorine is present in an amount of greater than 0 wt % and not greater than 2 wt %.

According to the present disclosure, based on 100 wt % of the glass composition, the zinc oxide is present in an amount of equal to or greater than 0 wt % and less than 0.25 wt %.

According to the present disclosure, an amount (M) of the manganese oxide, an amount (X) of the first component, the amount (A) of the aluminum oxide, the amount(S) of the silicon dioxide, the amount (B) of the diboron trioxide, and an amount (Y) of the second component satisfy the following Equations (1) to (III):

$$M + X \leq 4.5 , \qquad ( I )$$

$$( M + X ) \times \frac{1}{A} = 0.2 ∼ 0.45 , and \qquad ( II )$$

$${( \frac{S}{B} )}^{2} \times {X}^{3 / 2} + 2 \times Y \times {( \frac{15}{A} )}^{2} = 16 ∼ 38.5 . \qquad ( III )$$

With designation of the aforesaid compounds and the first and second components, requirement of the amount ranges thereof, and satisfaction of Equations (I) to (III), the glass composition of the present disclosure not only has the properties of having a dielectric constant of less than 4.3 and a dielectric loss tangent of less than 0.0015 in an environment having a frequency of 10 GHz, but also has good uniformity, good forming window, and good structural stability. “Good uniformity” indicates that a glass or a glass fiber formed from the glass composition has a homogeneous phase (i.e., the glass composition is in a state without phase separation). “Good forming window” indicates that a value of a forming window of the glass composition is greater than 50° C., which favors a spinning process for forming the glass fiber from the glass composition. In addition, “Good structural stability” indicates that no cracks are generated in the glass or the glass fiber formed from the glass composition.

The designation of the amount ranges of the compounds and the first and second components in the glass composition of the present disclosure is further described below.

Based on 100 wt % of the glass composition, when the silicon dioxide is present in the amount(S) ranging from 52 wt % to 62 wt %, and the diboron trioxide is present in the amount (B) ranging from 19 wt % to 31 wt %, the glass composition has an appropriate viscosity, low dielectric properties (i.e., a low dielectric constant and a low dielectric loss tangent), and good structural stability, so that cracking is less likely to occur in the glass or the glass fiber formed from the glass composition, thereby avoiding problems such as poor quality and poor yield.

Based on 100 wt % of the glass composition, when the silicon dioxide is present in the amount(S) ranging from 52 wt % to 62 wt %, the diboron trioxide is present in the amount (B) ranging from 19 wt % to 31 wt %, and the aluminum oxide is present in the amount (A) ranging from 8 wt % to 13 wt %, the glass composition has a good forming window, lower dielectric properties, and better structural stability.

When the fluorine is present in the amount of greater than 0 wt % and not greater than 2 wt % based on 100 wt % of the glass composition, the glass composition has low dielectric properties. Moreover, controlling the amount of the fluorine to be not greater than 2 wt % can reduce corrosion thereof to refractory bricks of a kiln, which shortens the service life of the kiln and increases production costs.

The zinc oxide is an optionally added compound. In other words, the glass composition may or may not contain the zinc oxide. When the glass composition includes the zinc oxide that is present in an amount of greater than 0 wt % and less than 0.25 wt % based on 100 wt % of the glass composition, the glass composition has low dielectric properties and good structural stability.

It should be noted that, if, in the glass composition, the amount (M) of manganese oxide and the amount (X) of the first component only satisfy Equation (I) (i.e., M+X≤4.5), the glass composition thus obtained may have low dielectric properties, but both uniformity and forming window thereof may be poor. As a result, by limiting the amount (A) of the aluminum oxide to range from 8 wt % to 13 wt %, and simultaneously allowing the amount (M) of manganese oxide, the amount (X) of the first component, and the amount (A) of the aluminum oxide to satisfy Equation (II) (i.e., (M+X)/A=0.2˜0.45), the glass composition thus obtained not only has low dielectric properties, but also has good uniformity and a good forming window.

Although the second component can impart lower dielectric properties and better structural stability to the glass composition than the first component, the second component is less effective than the first component in reducing viscosity of the glass composition, and is likely to cause a decrease in the value of forming window. Therefore, by provision of Equation (III), the amount (X) of the first component and the amount (Y) of the second component can be coordinated, so as to allow the glass composition to exhibit well-balanced performance among dielectric properties, structural stability, viscosity, and forming window. In addition, when the ratio of the amount(S) of the silicon dioxide to the amount (B) of the diboron trioxide becomes greater (i.e., the value of S/B is greater), the structural stability of the glass composition improves, but the viscosity thereof increases, which is not conducive to the manufacture of the glass or the glass fiber, and may cause deterioration in dielectric properties. In contrast, when the ratio of the amount(S) of the silicon dioxide to the amount (B) of the diboron trioxide becomes smaller (i.e., the value of S/B is smaller), the structural stability of the glass composition becomes poor even though the viscosity thereof may reduce and dielectric properties thereof can be improved. When the amount (A) of the aluminum oxide becomes greater (i.e., the value of A is greater), the structural stability and dielectric properties of the glass composition tend to deteriorate. In contrast, when the amount (A) of the aluminum oxide becomes smaller (i.e., the value of A is smaller), the structural stability of the glass composition becomes better, and dielectric properties thereof is enhanced (i.e., lower dielectric properties can be obtained). In consideration of the aforesaid situations, the glass composition of the present disclosure is required to simultaneously satisfy Equations (I) to (III) so as to have an appropriate viscosity, low dielectric properties, good structural stability, a good forming window, and good uniformity.

When a total amount (S+B) of the amount(S) of the silicon dioxide and the amount (B) of the diboron trioxide is not less than 73 wt % based on 100 wt % of the glass composition, the glass composition has a more appropriate viscosity and better structural stability. In certain embodiments, the total amount (S+B) of the amount(S) of the silicon dioxide and the amount (B) of the diboron trioxide may be not less than 77 wt %. In certain embodiments, the total amount (S+B) of the amount(S) of the silicon dioxide and the amount (B) of the diboron trioxide may be not less than 81 wt %. When a value ((S+B)/A; hereinafter referred to as “Q”) of the total amount (S+B) of the amount(S) of the silicon dioxide and the amount (B) of the diboron trioxide divided by the amount (A) of the aluminum oxide is not less than 6.1, the glass composition has lower dielectric properties and a better forming window. In some embodiments, the value (Q) may be not less than 6.4. In still some embodiments, the value (Q) may be not less than 6.7. In other embodiments, the amount (A) of the aluminum oxide, the amount(S) of the silicon dioxide, and the amount (B) of the diboron trioxide satisfy the following Equations (IV) and (V):

$$S + B = 81 ∼ 87.5 , and \qquad ( IV )$$

$$( S + B ) \times \frac{1}{A} = 6.7 ∼ 9.5 . \qquad ( V )$$

In certain embodiments, the first component may further include magnesium oxide (MgO). Coexistence of the magnesium oxide and the calcium oxide produces a mixed alkali effect, which allows the glass composition to have a better coefficient of thermal expansion, a better mechanical strength, and better dielectric properties.

In certain embodiments, the glass composition may further include titanium dioxide (TiO₂) present in an amount of greater than 0 wt % and not greater than 2 wt % based on 100 wt % of the glass composition. When the amount of the titanium dioxide falls within the aforesaid range, the glass composition has lower dielectric properties while maintaining a good forming window.

In certain embodiments, the glass composition may further include iron oxide (Fe₂O₃) present in an amount of greater than 0 wt % and not greater than 1 wt % based on 100 wt % of the glass composition. The presence of the iron oxide helps in monitoring of the state of the glass composition during melting, and enhances the stability thereof during a bubble-removing process. In addition, when the amount of the iron oxide falls within the aforesaid range, the glass composition has lower dielectric properties.

Under the premise of not damaging dielectric properties, the glass composition of the present disclosure may further include a material. In some embodiments, the material may be selected from the group consisting of sodium oxide (Na₂O), potassium oxide (K₂O), lithium oxide (Li₂O), chromium (III) oxide (Cr₂O₃), arsenic trioxide (As₂O₃), antimony trioxide (Sb₂O₃), vanadium pentoxide (V₂O₅), phosphorus pentoxide (P₂O₅), chlorine (Cl₂), beryllium oxide (BeO), barium oxide (BaO), scandium oxide (Sc₂O₃), tin (IV) oxide (SnO₂), strontium oxide (SrO), and combinations thereof. Based on 100 wt % of the glass composition, the material may be present in an amount of greater than 0 wt % and not greater than 2 wt %.

According to the present disclosure, the aforesaid glass composition may be subjected to a heating and melting treatment, followed by a cooling treatment, thereby obtaining a glass. According to the present disclosure, the aforesaid glass composition may be subjected to a heating and melting treatment, followed by a spinning and forming process, thereby obtaining a glass fiber.

### [Glass]

Therefore, the present disclosure also provides a glass, which includes the glass composition of the present disclosure. The glass composition has been described above, and details thereof will not be described.

The method for preparing the glass is not particularly limited. In some embodiments, the method may include the steps of: melting the glass composition, so as to obtain a liquid glass (i.e., the glass composition that is in a molten state); and cooling the glass liquid, so as to obtain the glass. The shape of the glass is not particularly limited. In some embodiments, the glass may be in a block shape. The conditions, parameters, and procedures for preparing the glass are within the expertise and routine skills of those skilled in the art, and details thereof will not be described.

Since the glass composition of the present disclosure has advantages of having a low dielectric constant, a low dielectric loss tangent, good structural stability, a good forming window, and good uniformity, the glass of the present disclosure, which is formed from the glass composition and hence includes the same, also has the above-mentioned advantages. In some embodiments, the glass may have a dielectric constant of less than 4.3 at a frequency of 10 GHz. In still some embodiments, the glass may have a dielectric loss tangent of less than 0.0015 at a frequency of 10 GHz.

### [Glass Fiber]

The present disclosure further provides a glass fiber, which includes the glass composition of the present disclosure. The glass composition has been described above, and details thereof will not be described.

The method for preparing the glass fiber is not particularly limited. In some embodiments, the method may include the steps of: melting the glass composition, so as to obtain a liquid glass (i.e., the glass composition that is in a molten state); and spinning the liquid glass, so that the liquid glass is formed into the glass fiber. The conditions, parameters, and procedures for preparing the glass fiber are within the expertise and routine skills of those skilled in the art, and details thereof will not be described.

Since the glass composition of the present disclosure has advantages of having a low dielectric constant, a low dielectric loss tangent, good structural stability, a good forming window, and good uniformity, the glass fiber of the present disclosure, which is formed from the glass composition and hence includes the same, also has the above-mentioned advantages. In some embodiments, the glass fiber may have a dielectric constant of less than 4.3 at a frequency of 10 GHz. In still some embodiments, the glass fiber may have a dielectric loss tangent of less than 0.0015 at a frequency of 10 GHz.

The present disclosure also provides a product, which includes the aforesaid glass fiber. The glass fiber has been described above, and details thereof will not be described. Examples of the product may be selected from the group consisting of a printed circuit board, an integrated circuit board, and a radome, but are not limited thereto. Since the glass fiber of the present disclosure has the advantages of having a low dielectric constant, a low dielectric loss tangent, good structural stability, a good forming window, and good uniformity, the product of the present disclosure, which is formed from the glass fiber and hence includes the same, also has low dielectric properties, and thus the product is ensured to have a high yield.

By virtue of inclusion of the above-mentioned compounds and the first and second components, and the required amounts thereof, and by virtue of satisfaction of Equations (I) to (III), the glass composition of the present disclosure not only has a low dielectric constant, a low dielectric loss tangent and good structural stability, but also has a food forming window and good uniformity. In addition, the glass of the present disclosure or the glass fiber of the present disclosure, which is formed from such glass composition and hence includes the same, also has the aforesaid advantages. Furthermore, the product of the present disclosure, which includes such glass fiber, has low dielectric properties, and thus the product is ensured to have a high yield.

The present disclosure will be further described by way of the following examples. However, it should be understood that the following examples are intended solely for the purpose of illustration and should not be construed as limiting the present disclosure in practice.

### Preparation of Glass Composition

### Example 1 (E1)

The glass composition of E1 was prepared using the recipe shown in Table 1 below, and procedures for preparation of the same are described as follows. Briefly, silicon dioxide (SiO₂), aluminum oxide (Al₂O₃), diboron trioxide (B₂O₃), magnesium oxide (MgO), calcium oxide (CaO) (the former two serve as a first component), titanium dioxide (TiO₂), fluorine (F₂), iron oxide (Fe₂O₃), zirconium dioxide (ZrO₂), and manganese oxide (MnO) (the former two serve as a second component) were mixed, so as to obtain the glass composition of E1. Based on 100 wt % of the glass composition of E1, the silicon dioxide was present in an amount(S) of 59.0 wt %, the aluminum oxide was present in an amount (A) of 12.0 wt %, the diboron trioxide was present in an amount (B) of 24.3 wt %, the magnesium oxide was present in an amount of 0.2 wt %, the calcium oxide was present in an amount of 2.2 wt % (i.e., the first component was present in an amount (X) of 2.4 wt %), the titanium dioxide was present in an amount of 0.5 wt %, the fluorine was present in an amount of 1.0 wt %, the iron oxide was present in an amount of 0.2 wt %, the zirconium dioxide was present in an amount of 0.3 wt %, and the manganese oxide (M) was present in an amount of 0.3 wt % (i.e., the second component was present in an amount (Y) of 0.6 wt %).

### Examples 2 to 7 (E2 to E7) and Comparative Examples 1 to 6 (CE1 to CE6)

The procedures for preparing the glass composition of each of E2 to E7 and CE 1 to CE6 were generally similar to those of E1, except that zinc oxide was used in each of E4 and CE3, and that the amount of each compound therein was varied as shown in Tables 1 and 2 below.

### Property Evaluation

### A. Preparation of Glass Block

The glass composition of each of E1 to E7 and CE1 to CE6 was placed in a high-temperature furnace and heated at a temperature ranging from 1500° C. to 1600° C. for a time period ranging from 1 hour to 4 hours, so that the glass composition was in a completely molten state (i.e., a liquid glass). Afterward, the liquid glass was poured into a graphite crucible having a diameter of 40 mm, followed by placing the graphite crucible with the liquid glass therein into an annealing furnace that had been preheated to 800° C., so as to cool down the liquid glass in the graphite crucible to room temperature (25° C.), thereby obtaining a glass block of each of E1 to E7 and CE1 to CE6.

### B. Determination of Dielectric Constant (Dk) and Dielectric Loss Tangent (Df)

The glass block of each of E1 to E7 and CE1 to CE6 obtained in Section A was cut, ground, and polished, so as to obtain a test piece of the glass block having a thickness ranging from 0.60 mm to 0.79 mm. Subsequently, the test piece was subjected to measurements of dielectric constant and dielectric loss tangent at a frequency of 10 GHz using a vector network analyzer (R&S; Model: ZNB20) coupled with a split post dielectric resonator (Waveray Technology Co., Ltd.), thereby obtaining a dielectric constant and a dielectric loss tangent of the glass block of each of E1 to E7 and CE1 to CE6. The results are shown in Tables 1 and 2 below.

### C. Determination of Forming Window (ΔT)

First, 2.25 g of the glass block of each of E1 to E7 and CE1 to CE6 obtained in Section A was placed in a high-temperature furnace, and then the high-temperature furnace was heated to a predetermined temperature and maintained at that temperature for 2 hours. After that, the glass block was taken out from the high-temperature furnace and left to cool down to room temperature (25° C.), followed by observation of whether a crystallization phenomenon occurred therein. If crystallization was present in the glass block, such predetermined temperature was the devitrification temperature of the glass composition. The forming window (ΔT) of the glass composition was determined by subtracting the devitrification temperature from a temperature at which the glass composition has a viscosity of 1000 poise. The greater the forming window was, the more conducive a spinning process for forming a glass fiber was. The results are shown in Tables 1 and 2 below.

### D. Determination of Uniformity

The glass block of each of E1 to E7 and CE1 to CE6 obtained in Section A was subjected to determination of uniformity by visual observation. If the glass block appeared to have an even distribution of hue, the glass block had a homogeneous phase (i.e., the glass block was in a state without phase separation), and hence had good uniformity (noted as “O”). If the glass block appeared to be opaque and had uneven distribution of hue, the glass block had a non-homogeneous phase (i.e., the glass block was in a state with phase separation), and hence had poor uniformity (noted as “X”). The results are shown in Tables 1 and 2 below.

### E. Determination of Structural Stability

The glass block of each of E1 to E7 and CE1 to CE6 obtained in Section A was cut, ground, and polished, so as to obtain a test piece of the glass block having a thickness ranging from 0.60 mm to 0.79 mm. Subsequently, the test piece was placed in an environment having room temperature (25° C.) for 7 days, and then subjected to determination of structural stability by visual observation. If surfaces of the test piece were intact (i.e., no cracks was observed on the surfaces thereof), the glass composition was determined to have good structural stability (noted as “O”). If cracks were observed on the surfaces of the test piece, the glass composition was determined to have poor structural stability (noted as “X”). The results are shown in Tables 1 and 2 below.

TABLE 1

| | | | Examples | | | | | | |
|---|---|---|---|---|---|---|---|---|---|
| | | | E1 | E2 | E3 | E4 | E5 | E6 | E7 |
| Amount | SiO₂ | | 59.0 | 54.3 | 55.7 | 55.5 | 58.0 | 59.0 | 52.9 |
| of | Al₂O₃ | | 12.0 | 10.5 | 9.5 | 10.0 | 11.0 | 10.0 | 10.0 |
| | B₂O₃ | | 24.3 | 29.0 | 29.0 | 28.0 | 27.0 | 25.0 | 30.3 |
| | First | MgO | 0.2 | 0.2 | 0.0 | 0.5 | 0.2 | 0.3 | 0.5 |
| | component | CaO | 2.2 | 2.3 | 2.6 | 2.3 | 2.0 | 2.7 | 2.5 |
| | TiO₂ | | 0.5 | 0.1 | 0.0 | 1.1 | 0.2 | 0.6 | 0.1 |
| | F₂ | | 1.0 | 1.4 | 0.7 | 0.7 | 0.8 | 0.2 | 0.7 |
| | ZnO | | 0.0 | 0.0 | 0.0 | 0.2 | 0.0 | 0.0 | 0.0 |
| | Fe₂O₃ | | 0.2 | 0.2 | 0.2 | 0.2 | 0.2 | 0.3 | 0.2 |
| | Second | ZrO₂ | 0.3 | 0.5 | 1.8 | 1.0 | 0.4 | 1.0 | 2.0 |
| | component | MnO | 0.3 | 1.5 | 0.5 | 0.5 | 0.2 | 0.9 | 0.8 |

| Total amount (wt %) | | 100.0 | 100.0 | 100.0 | 100.0 | 100.0 | 100.0 | 100.0 |
|---|---|---|---|---|---|---|---|---|
| Value calculated | | 2.7 | 4.0 | 3.1 | 3.3 | 2.4 | 3.9 | 3.8 |
| using Equation (I) | | | | | | | | |
| Value calculated | | 0.23 | 0.38 | 0.33 | 0.33 | 0.22 | 0.39 | 0.38 |
| using Equation (II) | | | | | | | | |
| Value calculated | | 23.8 | 22.0 | 26.9 | 25.2 | 17.3 | 37.5 | 28.4 |
| using Equation (III) | | | | | | | | |
| Value calculated | | 83.3 | 83.3 | 84.7 | 83.5 | 85.0 | 84.0 | 83.2 |
| using Equation (IV) | | | | | | | | |
| Value calculated | | 6.9 | 7.9 | 8.9 | 8.4 | 7.7 | 8.4 | 8.3 |
| using Equation (V) | | | | | | | | |
| Property | Dk (10 GHz) | 4.12 | 4.15 | 4.16 | 4.12 | 4.12 | 4.20 | 4.21 |
| evaluation | Df (10 GHz) | 0.0012 | 0.0011 | 0.0011 | 0.0012 | 0.0011 | 0.0013 | 0.0014 |
| | ΔT (° C.) | >50 | >50 | >50 | >50 | >50 | >50 | >50 |
| | Uniformity | ◯ | ◯ | ◯ | ◯ | ◯ | ◯ | ◯ |
| | Structural | ◯ | ◯ | ◯ | ◯ | ◯ | ◯ | ◯ |
| | stability | | | | | | | |

TABLE 2

| | | | Comparative Examples | | | | | |
|---|---|---|---|---|---|---|---|---|
| | | | CE1 | CE2 | CE3 | CE4 | CE5 | CE6 |
| Amount | SiO₂ | | 56.0 | 57.5 | 55.8 | 55.2 | 57.0 | 57.1 |
| of | Al₂O₃ | | 11.0 | 11.2 | 11.0 | 11.0 | 12.0 | 9.5 |
| | B₂O₃ | | 29.0 | 24.0 | 28.0 | 26.0 | 26.6 | 27.0 |
| | First | MgO | 0.2 | 0.5 | 0.0 | 0.5 | 0.4 | 1.4 |
| | component | CaO | 2.0 | 2.5 | 2.3 | 2.8 | 1.5 | 2.0 |
| | TiO₂ | | 0.2 | 0.5 | 0.5 | 1.6 | 0.0 | 0.5 |
| | F₂ | | 0.8 | 1.0 | 0.7 | 0.5 | 0.6 | 0.8 |
| | ZnO | | 0.0 | 0.0 | 0.5 | 0.0 | 0.0 | 0.0 |
| | Fe₂O₃ | | 0.2 | 0.2 | 0.2 | 0.2 | 0.2 | 0.2 |
| | Second | ZrO₂ | 0.3 | 1.1 | 0.5 | 0.5 | 1.5 | 0.5 |
| | component | MnO | 0.3 | 1.5 | 0.5 | 1.7 | 0.2 | 1.0 |

| Total amount (wt %) | | 100.0 | 100.0 | 100.0 | 100.0 | 100.0 | 100.0 |
|---|---|---|---|---|---|---|---|
| Value calculated | | 2.5 | 4.5 | 2.8 | 5.0 | 2.1 | 4.4 |
| using Equation (I) | | | | | | | |
| Value calculated | | 0.23 | 0.40 | 0.25 | 0.45 | 0.18 | 0.46 |
| using Equation (II) | | | | | | | |
| Value calculated | | 14.4 | 39.2 | 17.6 | 35.2 | 17.3 | 35.5 |
| using Equation (III) | | | | | | | |
| Value calculated | | 85.0 | 81.5 | 83.8 | 81.2 | 83.6 | 84.1 |
| using Equation (IV) | | | | | | | |
| Value calculated | | 7.7 | 7.3 | 7.6 | 7.4 | 7.0 | 8.9 |
| using Equation (V) | | | | | | | |
| Property | Dk (10 GHz) | 4.17 | 4.33 | 4.15 | 4.44 | 4.14 | 4.20 |
| evaluation | Df (10 GHz) | 0.0011 | 0.0017 | 0.0012 | 0.0018 | 0.0010 | 0.0013 |
| | ΔT (° C.) | >50 | >50 | >50 | >50 | <50 | >50 |
| | Uniformity | ◯ | ◯ | ◯ | ◯ | ◯ | X |
| | Structural | X | ◯ | X | ◯ | ◯ | ◯ |
| | stability | | | | | | |

Referring to Tables 1 and 2, by limiting the amount(S) of the silicon dioxide to range from 52 wt % to 62 wt %, the amount (A) of the aluminum oxide to range from 8 wt % to 13 wt %, the amount (B) of the diboron trioxide to range from 19 wt % to 31 wt %, the amount of the fluorine to be greater than 0 wt % and not greater than 2 wt %, and the amount of the zinc oxide (if any) to be greater than 0 wt % and less than 0.25 wt %, and simultaneously, by satisfying Equations (I) to (III), the glass block of each of E1 to E7, which is correspondingly formed from the glass composition of each of E1 to E7, had a low dielectric constant, a low dielectric loss tangent, a good forming window, good uniformity, and good structural stability. “Low dielectric constant” meant that the value of a dielectric constant was less than 4.3. “Low dielectric loss tangent” meant that the value of a dielectric loss tangent was less than 0.0015. In addition, “Good forming window” meant that the value of a forming window (° C.) was greater than 50, which was conducive to a spinning process for forming a glass fiber.

In comparison with the glass block of CE1 formed from the glass composition of CE1, in which the value (14.4) calculated using Equation (III) was less than 16, leading to poor structural stability of the glass block of CE1, and compared with the glass block of CE2 that was formed from the glass composition of CE2, in which the value (39.2) calculated using Equation (III) was greater than 38.5, causing the glass block of CE2 to have a dielectric loss tangent (0.0017) of not less than 0.0015, the glass block of each of E1 to E7, which was correspondingly formed from the glass composition of each of E1 to E7, had a low dielectric constant, a low dielectric loss tangent, a good forming window, good uniformity, and good structural stability because such glass blocks satisfied Equation (III) (i.e., the value calculated using Equation (III) ranged from 16 to 38.5).

In comparison with the glass block of CE3 formed from the glass composition of CE3, in which the amount (0.5 wt %) of the zinc oxide was not less than 0.25 wt %, leading to poor structural stability of the glass block of CE3, the glass block of E4 that was formed from the glass composition of E4 had a low dielectric constant, a low dielectric loss tangent, a good forming window, good uniformity, and good structural stability because the zinc oxide thereof was present in an amount (0.2 wt %) of less than 0.25 wt %.

In comparison with the glass block of CE4 formed from the glass composition of CE4, in which the value (5.0) calculated using Equation (I) was greater than 4.5, causing the glass block of CE4 to have a dielectric loss tangent (0.0018) of not less than 0.0015, the glass block of each of E1 to E7, which was corresponding formed from the glass composition of each of E1 to E7, had a low dielectric constant, a low dielectric loss tangent, a good forming window, good uniformity, and good structural stability because such glass blocks satisfied Equation (I) (i.e., the value calculated using Equation (I) was not greater than 4.5).

Additionally, in comparison with the glass block of CE5 formed from the glass composition of CE5, in which the value (0.18) calculated using Equation (II) was less than 0.2, leading to a poor forming window of the glass block of CE5, and compared with the glass block of CE6 formed from the glass composition of CE6, in which the value (0.46) calculated using Equation (II) was greater than 0.45, leading to a poor uniformity of the glass block of CE6, the glass block of each of E1 to E7, which was correspondingly formed from the glass composition of each of E1 to E7, had a low dielectric constant, a low dielectric loss tangent, a good forming window, good uniformity, and good structural stability because such glass block satisfied Equation (II) (i.e., the value calculated using Equation (II) ranged from 0.2 to 0.45).

By virtue of inclusion of the aforesaid compounds and the required amounts thereof, and by virtue of satisfaction of the Equations, the glass composition of the present disclosure not only has a low dielectric constant, a low dielectric loss tangent and good structural stability, but also has a good forming window and good uniformity. Moreover, the glass of the present disclosure (e.g., the glass block of each of E1 to E7) or the glass fiber of the present disclosure, which is formed from such glass composition and hence includes the same, also has the aforesaid advantages. Therefore, the product of the present disclosure, which includes such glass fiber, has low dielectric properties, and thus is ensured to have a high yield. Accordingly, the purpose of the invention can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A glass composition, comprising:
silicon dioxide (SiO₂);
aluminum oxide (Al₂O₃);
diboron trioxide (B₂O₃);
fluorine (F₂);
zinc oxide (ZnO);
a first component including calcium oxide (CaO); and
a second component including zirconium dioxide (ZrO₂) and manganese oxide (MnO);
wherein based on 100 wt % of the glass composition, the silicon dioxide is present in an amount(S) ranging from 52 wt % to 62 wt %, the aluminum oxide is present in an amount (A) ranging from 8 wt % to 13 wt %, the diboron trioxide is present in an amount (B) ranging from 19 wt % to 31 wt %, and the fluorine is present in an amount of greater than 0 wt % and not greater than 2 wt %,
wherein based on 100 wt % of the glass composition, the zinc oxide is present in an amount of equal to or greater than 0 wt % and less than 0.25 wt %, and
wherein an amount (M) of the manganese oxide, an amount (X) of the first component, the amount (A) of the aluminum oxide, the amount(S) of the silicon dioxide, the amount (B) of the diboron trioxide, and an amount (Y) of the second component satisfy the following Equations (I) to (III):
$$M + X \leq 4.5 , \qquad ( I )$$
$$( M + X ) \times \frac{1}{A} = 0.2 ∼ 0.45 , and \qquad ( II )$$
$${( \frac{S}{B} )}^{2} \times {X}^{3 / 2} + 2 \times Y \times {( \frac{15}{A} )}^{2} = 16 ∼ 38.5 . \qquad ( III )$$

2. The glass composition as claimed in claim 1, wherein the amount (A) of the aluminum oxide, the amount(S) of the silicon dioxide, and the amount (B) of the diboron trioxide satisfy the following Equations (IV) and (V):
$$S + B = 81 ∼ 87.5 , and \qquad ( IV )$$
$$( S + B ) \times \frac{1}{A} = 6.7 ∼ 9.5 . \qquad ( V )$$

3. The glass composition as claimed in claim 1, wherein the first component further includes magnesium oxide (MgO).

4. The glass composition as claimed in claim 1, further comprising titanium dioxide (TiO₂) present in an amount of greater than 0 wt % and not greater than 2 wt % based on 100 wt % of the glass composition.

5. The glass composition as claimed in claim 1, further comprising iron oxide (Fe₂O₃) present in an amount of greater than 0 wt % and not greater than 1 wt % based on 100 wt % of the glass composition.

6. A glass, comprising the glass composition as claimed in claim 1.

7. A glass fiber, comprising the glass composition as claimed in claim 1.

8. A product, comprising the glass fiber as claimed in claim 7.

9. The product as claimed in claim 8, which is selected from the group consisting of a printed circuit board, an integrated circuit board, and a radome.
